(19) United States
(12) Patent Application Publication
(10) Pub. No.: US 2006/0180097 A1
(43) Pub. Date: Aug. 17, 2006

(54) Pet stairs

(76) Inventor: Robert Notine, Brooklyn, NY (US)

Correspondence Address: STEVENS DAVIS MILLER & MOSHER, LLP, 1615 L STREET, NW, SUITE 850, WASHINGTON, DC, 20036, US

(21) Appl. No.: 11/055,011

(22) Filed: Feb. 11, 2005

(51) Int. Cl. A01K 29/00

(52) U.S. Cl. 119/847

(57) ABSTRACT

The present invention is a series of foamed steps, usable by an animal to climb to an elevated surface. The steps are covered in a plastic barrier layer to protect them from fluids.

### BACKGROUND OF THE INVENTION

1. Field of the Invention

This invention relates to portable stairs to allow pets, such as small or otherwise infirm dogs or animals, to easily climb onto beds, couches or other elevated surfaces.

2. Background

Traditionally, dogs and other pets were prohibited from going up onto elevated surfaces in the home, such as couches and beds. Pets were often considered dirty or denied access to these softer seating areas simply to maintain a clear hierarchy of dominance in the household.

Recently, however, as pets, such as dogs, are kept more as companions rather than working animals, the prohibition from couches and beds has eroded. As the population of the United States and many other nations grows older, and as these populations are waiting to have children later in life, the growth of pet-ownership has expanded greatly.

Just as the human populations of these countries is growing older due to advances in medicine, similar increases in age in pets has been observed. Thus, as the average age of the people of this, and many other countries, eases higher, so do that of our non-human companions.

Just as increased age of humans is generally concurrent with an increase in health problems, similar issues occur with our non-human companions. These health problems include arthritis, decreased range of motion and muscle weakness.

A common result of these health issues is an inability to reach elevated surfaces, such as couches, chairs and beds.

### SUMMARY OF THE INVENTION

Thus, the present invention is a series of steps or stairs, which are designed to be used by pets, such as dogs and cats, to enable them to reach the aforementioned elevated surfaces.

In a preferred embodiment, the stairs are formed of a foamed material, which can support the weight of the pet. In order to protect the foam material, the stairs are covered with an additional material, such as a removable faux-sheepskin, which can be removed for cleaning.

Additionally, a barrier may be placed between the cover and the foam. This barrier can be used to further protect the foam, and may take the form of a plastic bag, or other form fitted, liquid impermeable, material.

This invention also relates to a method of forming the stairs. For example, a series of blocks, all of the same size or of different size, can be adjoined or the shape of the stairs can be cut from a larger form. When the latter method is used, it is possible to create two units of, for example, the same dimension, from a single monolithic structure.

### BRIEF DESCRIPTION OF THE DRAWINGS

FIG. 1 is a side view of the invention.

FIG. 1A is an alternate method of forming the invention.

FIG. 2 is a side view of a method of forming the invention.

FIG. 3 is a perspective view of the invention.

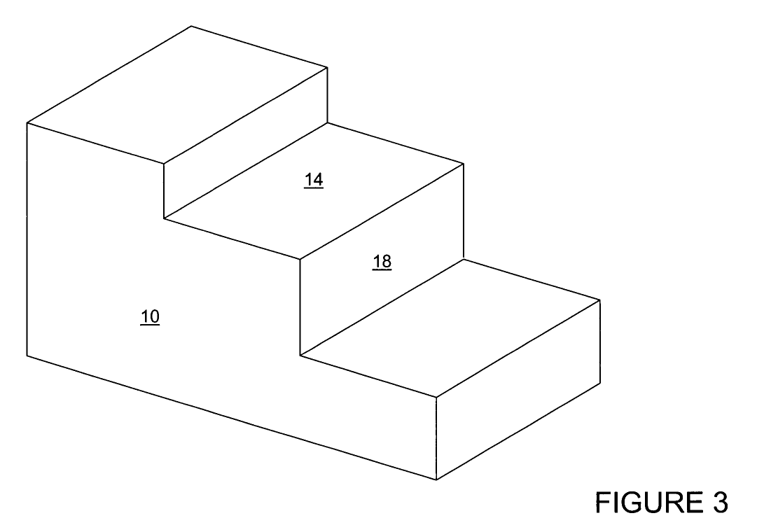

### DETAILED DESCRIPTION

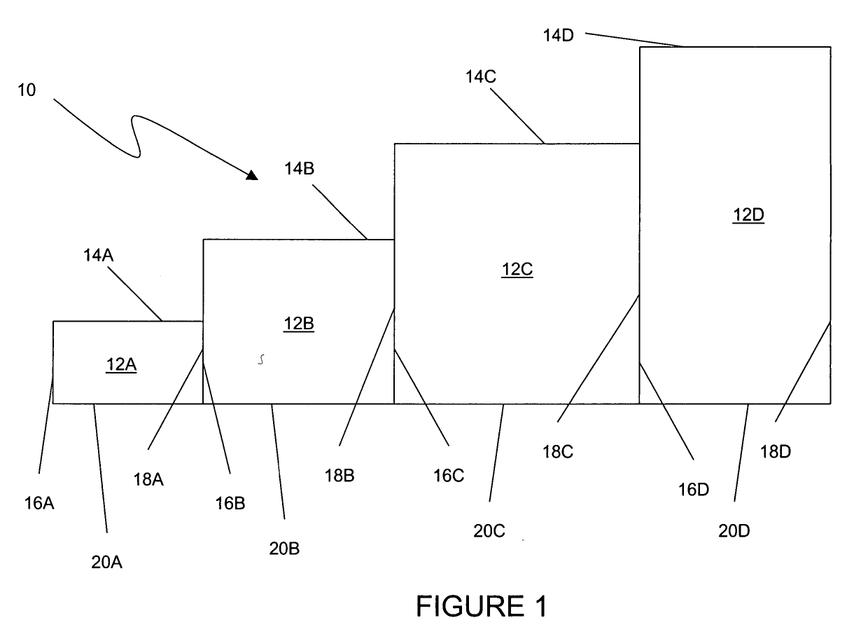

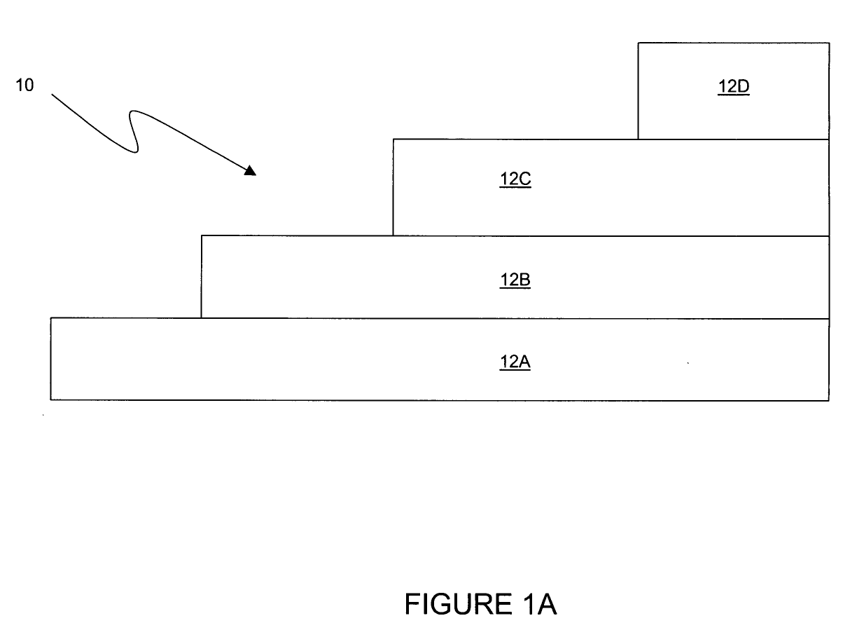

The present invention, as shown in FIG. 1, is a stair system 10, having a number of steps 12. The size of the various steps 12 is preferably selected to allow an animal, such as a dog or cat, to climb from a floor to an elevated surface, such as a chair or couch.

Just as is typical in stair systems for humans, the system of the invention includes steps which have a run 14 and a rise 16. In order to permit easy climbing, preferably, the ratio of run to rise is generally 10-13 to 6-8. This allows for a suitable sized run, while being short enough to be easily traversed. Although FIG. 1 shows the system 10 including four steps, 12A-12D, respectively, it is considered within the scope of the invention to vary the number of steps. In such embodiments, the system 10 may typically include as few as two, or as many as ten steps, but preferably, the system 10 is limited to between three and six steps, inclusive.

In one embodiment, the system 10 is assembled from a plurality of foam blocks which are affixed together. As shown in FIG. 1, steps 12A-12D are joined to form the rises 16A-14D. Specifically, the rises 16A-16D are formed from the front side of the blocks 12A-12D, as the back sides 18A-18D are, typically, glued to the front sides. Although not preferred, it is additionally possible to utilize one or more straps or bands, which, when placed around the blocks 12 in a tight manner, function to hold the system 10 together.

The size and shapes of the blocks 12 are selected as to form the desired configuration of the system 10. For example, to form a five step system, an additional block 12 can be utilized and joined to the other blocks 12 at any location in the system. Additionally, it is considered within the scope of the invention to utilize blocks 12 of all the same size, simply used in combination to achieve the familiar step configuration of the system.

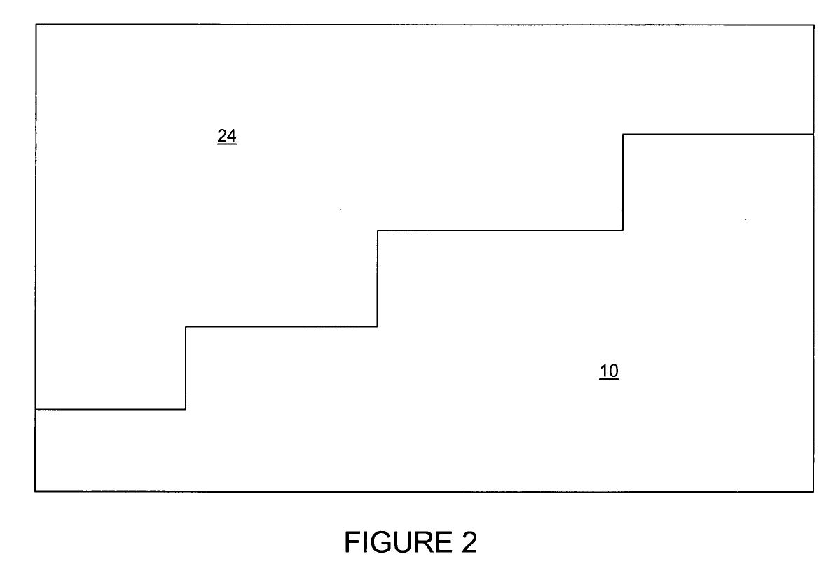

Additionally, as shown in FIG. 2, the system 10 can be cut from larger block 24, in order to form two systems.

Although the system 10 can be formed from any material, such as metal, wood or plastic, in a preferred embodiment, the blocks 12 are foamed. The foam can be any type of foam, such as open cell and closed cell, any chemical composition, such as polystyrene, polyurethane, polyisocyanurate, and other foamed polymeric materials. These foams can be expanded, extruded, molded or formed in any conventional method. These foams can have any density, provided they have sufficient strength alone, or in combination with internal or external reinforcement to support the weight of the animal.

Typical closed cell foams include Aerogel, Airex, FloTex, latex, polychloroprene (e.g, Neoprene), polyethylene, and polystyrene foams.

Typically, the system 10 is provided with a cover. In one embodiment, the cover is simply a soft surface, such as (real or faux) sheepskin, fleece, cotton, acrylic, or other covering, which is placed over the system 10. Preferably, the coverings are designed to be removable and preferably washable. Suitable reinforcement includes metal, prefabricated polymer sheets, bars, rods and trusses, wood, veneers, laminates, fibers, filaments, and tows and rope. The system 10 may also include a barrier layer, such as a layer of plastic which protects the blocks 12. The barrier layer may protect the blocks 12 from pet excretions, such as urine, feces, saliva and other fluids. In one embodiment, the blocks 12 are shrink-wrapped (or otherwise heat-sealed) inside the barrier layer, while in other embodiments, the barrier layer may be disposable/replaceable, and optionally provided with closing elements, such as snaps, hook-and-loop fasteners (e.g., VELCRO), zippers, and buttons, as can the soft surface. In a particularly preferred embodiment, the barrier layer acts as an external reinforcement for the foamed blocks.

Although any thickness for the barrier layer can function to protect the blocks 12, preferably the barrier layer includes a layer of, for example, low density polyethylene (LDPE), having a thickness of between 0.5 and 50 mils, typically between 1 and 5 mils, and more typically between 2 and 4 mils. Although increased thickness functions to better protect the blocks 12, as well as acting as the external reinforcement, the increased thickness will necessarily increase cost of the barrier layer.

It should be apparent from this description that embodiments other than those described above come within the spirit and scope of the present invention. Finally, due to the construction, the vessels can be re-used, if only for limited times. Additionally, although the above-description has been made using a liquid, any fluid or combination of fluids may be used in either chamber.

1. A system of stairs for animals comprising:
foam in the shape of a plurality of stairs,
said plurality of stairs comprising alternating rises and runs,
further comprising a barrier layer surrounding said plurality of stairs, wherein said barrier layer is impervious to bodily fluids and is heat sealed about said plurality of stairs, and
a removable cover, placed over said barrier layer.

2. (canceled)

3. The system of claim 1, wherein said removable cover is not impervious to bodily fluids.

4. The system of claim 1, wherein said barrier layer comprises a polymer.

5. The system of claim 4, wherein said polymer comprises an olefin.

6. (canceled)

7. The system of claim 1, wherein said barrier layer has a thickness of at least 0.5 mils.

8. (canceled)

9. The system of claim 1, wherein said foam is selected from the group consisting of open cell foams and closed cell foams.

10. The system of claim 1, wherein said foam is selected from the group consisting of polyurethane, polyisocyanurate, polystyrene polychloroprene and polyethene foam.

11. A method of forming a system of stairs for animals comprising:
forming a plurality of blocks to thereby form a plurality of stairs from a foamed material, having alternating rises and runs;
shrink-wrapping said plurality of stairs in a barrier layer wherein said barrier layer is impervious to bodily fluids, and providing a removable cover, to be placed over said barrier layer.

12. (canceled)

13. The method of claim 11, wherein said barrier layer comprises a polymer.

14. The method of claim 13, wherein said polymer comprises an olefin.

15. (canceled)

16. The method of claim 11, wherein said barrier layer comprises closing elements.

17. The method of claim 11, further comprising forming said foamed material from a single foam block.

18. The method of claim 11, wherein said foamed material is selected from the group consisting of open cell foams and closed cell foams.

19. The method of claim 11, wherein said foamed material is selected from the group consisting of polyurethane, polyisocyanurate, polystyrene, polychloroprene and polyethene foam.

20. A system of stairs for animals comprising:
foam in the shape of a plurality of stairs,
said plurality of stairs comprising alternating rises and runs, and
further comprising a barrier layer surrounding said plurality of stairs, wherein said barrier layer is impervious to bodily fluids and is shrink-wrapped about said plurality of stairs.

21. The system of claim 20, further comprising a removable cover, placed over said barrier layer.

22. The system of claim 1, wherein said plurality of stairs is formed from a single piece of foam.

23. The system of claim 1, wherein said plurality of stairs further comprises a second block of foam.

24. The system of claim 1, wherein said barrier layer is in the form of a bag.

25. The system of claim 1, wherein the plurality of stairs comprises reinforcements.

26. The system of claim 1, wherein the barrier layer comprises an external reinforcement.
